(19) United States
(12) Patent Application Publication
(10) Pub. No.: US 2025/0095897 A1
(43) Pub. Date: Mar. 20, 2025

(54) SOLENOID ACTUATOR WITH IMPROVED REACTION TIME

(71) Applicant: Schaeffler Technologies AG & Co. KG, Herzogenaurach (DE)

(72) Inventors: David Battle, Massillon, OH (US); Jordan Geiser, Massillon, OH (US); Mike Geiser, Orrville, OH (US)

(73) Assignee: Schaeffler Technologies AG & Co. KG, Herzogenaurach (DE)

(21) Appl. No.: 18/468,060

(22) Filed: Sep. 15, 2023

(51) Int. Cl. H01F 7/16; H01F 7/126

(52) U.S. Cl. CPC H01F 7/1607; H01F 7/126

(57) ABSTRACT

A solenoid actuator having a coil at least partially surrounding an axis, and an armature sleeve extending at least partially through the coil. The armature sleeve includes a longitudinally extending wall that extends generally parallel to the axis, and an end portion that extends inwardly at an end of the longitudinally extending wall. An armature is slidably supported in the armature sleeve for movement along the axis between at least first and second actuation positions. The armature has an armature body with an outer longitudinal surface facing the longitudinally extending wall and an end surface facing the end portion of the armature sleeve. The longitudinally extending wall has a sliding fit with the outer longitudinal surface of the armature. An oil reservoir space is formed on the armature in a region of an intersection between the outer longitudinal surface and the end surface of the armature.

### TECHNICAL FIELD

The disclosure relates to actuators having oil or another lubricating and/or cooling fluid within an actuator housing.

### BACKGROUND

Solenoid actuators may be used in “wet” applications in which they are subject to the ingress of oil or another lubricating and/or cooling fluid.

In one application in a vehicle transmission, the solenoid actuator may be used to actuate a clutch to engage or disengage rotating components or to ground a rotating component to a fixed structure such as a housing.

A solenoid actuator generally comprises a coil that can be energized as well as an armature that is moved at least in one direction by the coil being energized. In some “wet” applications, the oil or other fluid from the transmission or other arrangement where the actuator is located that enters the actuator assembly can negatively affect the travel time of the armature between switching positions due to the oil or other fluid damping the movement of the armature, particularly at low temperatures. This can negatively affect performance characteristics of the actuator and any components being actuated.

It would be desirable to provide a solenoid actuator for such an environment that addresses the issues in the known arrangement.

### SUMMARY

In one aspect, a solenoid actuator is provided that includes a coil at least partially surrounding an axis, and an armature sleeve extending at least partially through the coil. The armature sleeve includes a longitudinally extending wall that extends generally parallel to the axis, and an end portion that extends inwardly at an end of the longitudinally extending wall. An armature is slidably supported in the armature sleeve for movement along the axis between at least first and second actuation positions. The armature has an armature body with an outer longitudinal surface facing the longitudinally extending wall and an end surface facing the end portion of the armature sleeve. The longitudinally extending wall of the armature sleeve has a sliding fit with the outer longitudinal surface of the armature. An oil reservoir space is formed on the armature in a region of an intersection between the outer longitudinal surface and the end surface of the armature.

While a sliding fit will vary in size depending on a size/diameter of the armature, for an armature with a diameter of 10-25 mm, the clearance space between the outer surface of the armature and the longitudinally extending wall of the armature sleeve may be in the range of about 0.02-0.08 mm.

In one embodiment, the solenoid actuator includes a housing fixed to the coil and the housing has an armature receiving space that receives at least a portion of the armature sleeve into which the armature is movable in at least one of the actuation positions. The housing further includes a coil receiving space in which the coil is located, and a solenoid cover is located on an opposite side of the coil from the housing. This allows the solenoid actuator to be provided as a complete assembly.

In one embodiment, an actuator pin extends from the armature and through the cover. Here, an actuator pin support can be provided that is connected to the cover. A stop for the first actuation position of the armature can be formed on the actuator pin support. The actuator pin can extend through an opening in the actuator pin support.

In one embodiment, the oil reservoir space is annular. The annular space can have a wedge-shaped cross-section. Alternatively, the annular space can a generally rectilinear cross-section. Other cross-sectional shapes can also be used. Here, the goal is to provide a place for oil or other fluid, located between the armature and the armature sleeve that acts on the end face of the armature as it moves from the first actuation position to the second actuation position, to be received in order to reduce the damping effect of the oil or other fluid on the armature in order to prevent switching times from being negatively affected.

In one embodiment, the annular space has a height of at least about 0.4 mm to 1.0 mm, at the end surface of the armature. However, the height may vary depending on the size of the armature.

In one embodiment, the longitudinally extending wall of the armature sleeve is generally cylindrical, and the outer longitudinal surface of the armature is generally cylindrical. Other shapes may also be used.

In one embodiment, the end portion of the armature sleeve forms a travel end stop for the second actuation position of the armature.

In another aspect, an actuator assembly is provided that includes a support part and a solenoid actuator connected to the support part. The solenoid actuator includes a coil at least partially surrounding an axis, an armature sleeve extending at least partially through the coil, with the armature sleeve including a longitudinally extending wall that extends generally parallel to the axis, and an end portion that extends inwardly at an end of the longitudinally extending wall, with an armature slidably supported in the armature sleeve for movement along the axis between at least first and second actuation positions. The armature has an armature body having an outer longitudinal surface facing the longitudinally extending wall and an end surface facing the end portion of the armature sleeve, and an actuator pin extending from the armature. An actuation part is provided that is acted upon by the actuator pin in at least one of the first or second actuation positions. The longitudinally extending wall has a sliding fit with the outer longitudinal surface of the armature, and an oil reservoir space is formed on the armature in a region of an intersection between the outer longitudinal surface and the end surface of the armature. Here, the support part and the actuation part may be transmission components, and the solenoid assembly can be located in a “wet” area in a transmission in which oil or another hydraulic fluid is circulated.

In one embodiment, the solenoid actuator may further include a housing fixed to the coil and having an armature receiving space that receives at least a portion of the armature sleeve into which the armature is movable in at least one of the actuation positions and a coil receiving space in which the coil is located, and a solenoid cover is located on an opposite side of the coil from the housing.

In another embodiment, the solenoid actuator can include an actuator pin support connected to the cover, and a stop for the first actuation position of the armature formed on the actuator pin support. Here, the actuator pin extends through an opening in the actuator pin support.

In one embodiment, the oil reservoir space is annular. The annular space can have a wedge-shaped cross-section. Alternatively, the annular space can a generally rectilinear cross-section. Other cross-sectional shapes can also be used. Here, the goal is to provide a place for oil or other fluid between the armature and the armature sleeve to be received in order to reduce the damping effect of the oil or other fluid that acts on the end surface of the armature as it travels in order to prevent switching times from being negatively affected.

In one embodiment, the annular space has a height of at least about 0.4 mm-1.0 mm at the end surface of the armature. This height can vary based on the particular size of the armature.

In one embodiment, the longitudinally extending wall of the armature sleeve is generally cylindrical, and the outer longitudinal surface of the armature is generally cylindrical.

In one embodiment, the end portion of the armature sleeve forms a travel end stop for the second actuation position of the armature.

One or more of the above features can be combined to provide a solenoid actuator as well as an actuator assembly with improved performance.

### BRIEF DESCRIPTION OF THE DRAWING(S)

The foregoing Summary as well as the following Detailed Description will be best understood when read in conjunction with the appended drawings, which illustrate an embodiment according to the disclosure. In the drawings:

FIG. 1 is a cross-sectional view through an actuator assembly having a solenoid actuator according to the present disclosure, showing the solenoid actuator with the armature in a first actuation position.

FIG. 2 is a cross-sectional view similar to FIG. 1 showing the solenoid actuator with the armature in a second actuation position.

FIG. 3 is an enlarged view of an end portion of the armature according to the embodiment of the solenoid actuator shown in FIGS. 1 and 2.

FIG. 4 is an enlarged view of an end portion of the armature similar to FIG. 3 showing another embodiment of the solenoid actuator.

### DETAILED DESCRIPTION

Certain terminology is used in the following description for convenience only and is not limiting. “Axial” refers to a direction along an axis. A reference to a list of items that are cited as “at least one of a, b, or c” (where a, b, and c represent the items being listed) means any single one of the items a, b, or c, or combinations thereof. The terms “generally”, “about” and “approximately” are to be construed as within 10% of a stated value or ratio. The terminology includes the words specifically noted above, derivatives thereof, and words of similar import.

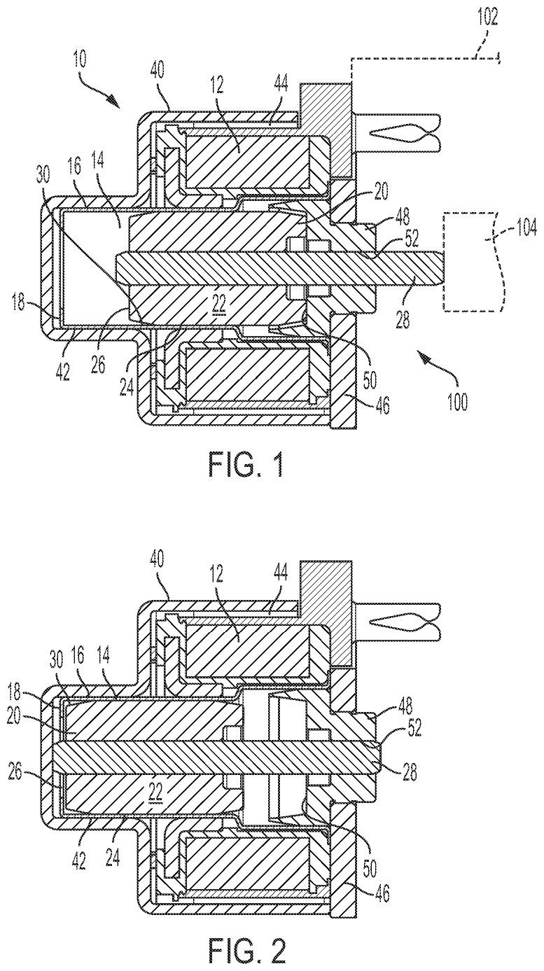

Referring to FIG. 1, an actuator assembly 100 having a solenoid actuator 10 according to the disclosure is shown. The actuator assembly 100 includes a support part 102 on which the solenoid actuator 10 is connected or otherwise supported as well as an actuation part 104 upon which the solenoid actuator 10 acts in order to move the actuation part 104 between at least first and second actuation positions.

Referring to FIGS. 1-3, the solenoid actuator 10 will be described in detail. The solenoid actuator 10 (“actuator 10”) includes a coil 12 that at least partially surrounds an axis X. An armature sleeve 14 extends at least partially through the coil 12, with the armature sleeve 14 including a longitudinally extending wall 16 that extends generally parallel to the axis X. An end portion 18 extends inwardly at an end of the longitudinally extending wall 16. The armature sleeve 14 is preferably made of a deep drawn metallic part, which can be for example, stainless steel. However, other materials can be utilized.

An armature 20 is slidably supported in the armature sleeve 14 for movement along the axis X between at least first and second actuation positions. In the illustrated embodiment, there are two actuation positions; however, a multi-field coil 12 could provide additional actuation positions. A spring, not shown, may be used to bias the armature 20 to one of the first or second actuation positions. In the present case, the first actuation position is as shown in FIG. 1 and is achieved when the coil 12 is energized and the B-field generated by the coil 12 acts on the armature 20, and the second actuation position is as shown in FIG. 2, and a spring can be used to bias the armature 20 to the second actuation position when the coil 12 is not energized.

The armature 20 has an armature body 22 having an outer longitudinal surface facing the longitudinally extending wall 16 as well as an end surface 26 facing the end portion 18 of the armature sleeve 14. The armature body 22 is made of a magnetic material, such as iron. However, other materials may also be used as long as they have magnetic properties so that they can be acted upon B-field generated by the coil 12 when it is energized.

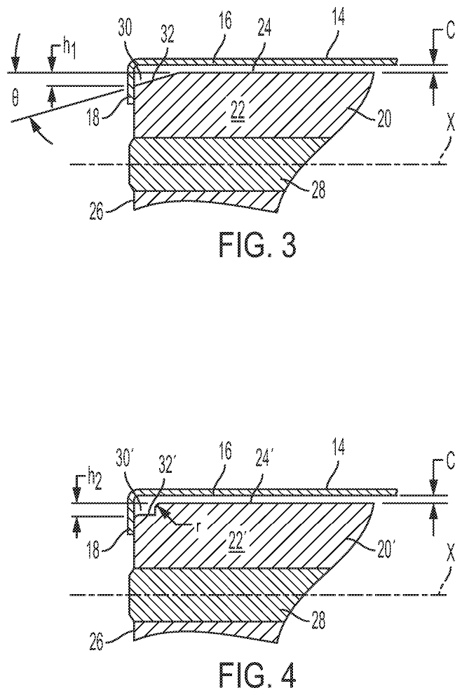

The longitudinally extending wall 16 of the armature sleeve 14 has a sliding fit with the outer longitudinal surface 24 of the armature 20. This sliding fit is indicated as clearance “C” in FIG. 3. As will be understood by those skilled in the art, the clearance C will vary depending upon the size of the solenoid actuator 10. In one embodiment, the armature 20 has a diameter of approximately 15 mm, and the clearance C is in a range of 0.02 to 0.08 mm. However, this clearance can vary depending upon the particular application and requirements.

One issue with the known prior art solenoids is that at low temperatures, oil or other hydraulic fluid within the solenoid based on installation in a “wet” environment, such as a transmission, is allowed to pass into the solenoid for both lubrication and cooling. Due to the relatively tight clearance fit C between the armature 20 and the armature sleeve 14, this oil or fluid is scrapped onto the armature end face 26 as the armature moves from the first actuation position, shown in FIG. 1, to the second actuation position, shown in FIG. 2. The oil or other hydraulic fluid in some instances cannot be moved out of the way quickly enough by the armature 20 to allow the process of the solenoid actuator 10 moving from the first actuation position to the second actuation position to be carried out within a specified time. This can be critical in transmission as well as other applications where a specified disengagement time is required. This issue becomes particularly apparent at low temperatures when the viscosity of the oil or fluid increases.

In order to address this, as shown in FIGS. 1 and 2 as well as in detail in FIG. 3, an oil reservoir space 30 is formed on the armature 20 in a region of an intersection between the outer longitudinal surface 24 and the end surface 26 of the armature 20. In the illustrated embodiment, the oil reservoir space 30 is annular. As shown in detail in FIG. 3, the annular space may have a wedge-shaped cross-section 32. In the illustrated embodiment, the wedge-shape has an angle θ which can be in the range of 5-30°, and more preferably is in the range of 10-20°. Preferably, the annular space 30 has a height H1 at the end surface 26, as shown in FIG. 3, that is at least about 0.4 mm, and may be from 0.4 mm-1.0 mm, or greater depending on the application. It has been found that this space allows for oil or other fluid to be collected and/or displaced more rapidly such that the movement time of the solenoid actuator 10 from the first actuation position to the second actuation position is improved, regardless of the viscosity of the oil or other fluid in the “wet” environment of the solenoid actuator 10.

As shown in FIG. 4 in which an alternate annular space 30′ is shown for the armature 20′, the annular space 30′ can have a generally rectilinear cross-section 34′. Here, the annular space 30′ has a height H2 that is also at least about 0.4 mm, and may be from 0.4 mm-1.0 mm, at the end surface 26′ of the armature 20′, or can be greater depending on the application. As shown in FIG. 4, preferably the rectilinear cross-section 34′ has a radius r to transition to the outer longitudinal surface 24′. Here, the radius r is greater than 0.2 mm. However, the specific dimensions may vary depending upon the overall size of the solenoid actuator 10 and the particular application. This arrangement provides the same advantages of the annular space 30 with the wedge-shaped cross-section 32. The remainder of the solenoid actuator 10 remains the same as explained above.

In the illustrated embodiment, the longitudinally extending wall 16 of the armature sleeve 14 is generally cylindrical, and the outer longitudinal surface 24 of the armature 20 is also generally cylindrical. However, this can vary depending upon the particular application.

Still with reference to FIGS. 1 and 2, the solenoid actuator 10 may include a housing 40 that is fixed to and/or supports the coil 12. The housing 40 includes an armature receiving space 42 that receives at least a portion of the armature sleeve 14 into which the armature 20 is moveable in at least one actuation position, here the second actuation position shown in FIG. 2. The housing 40 may also include a coil receiving space 44 in which the coil 12 is located, as well as a solenoid cover 46 located on an opposite side of the coil 12 from the housing 40.

As shown in FIGS. 1 and 2, an actuator pin 28 extends from the armature 20 and through the cover 46. The actuator pin 28 may be press fit into the armature 20, or the armature 20 could be formed with a pin, depending upon the particular application. The size and shape of the actuator pin 28 may vary depending on the application as well.

As shown in FIG. 1, the solenoid actuator 10 may also include an actuator pin support 48 connected to the cover 46 as well as a stop 50 for the first actuation position of the armature 20, shown in FIG. 1, which is formed on the actuator pin support 48. Here, the actuator pin 28 extends through an opening 52 in the actuator pin support 48. This can also have a sliding fit in order to accurately guide and support the actuator pin 28.

The solenoid actuator 10 as well as the actuator assembly 100 using the solenoid actuator 10 provides specific advantages with respect to engagement and/or disengagement times in a “wet” environment in order to maintain fast and smooth operation of the solenoid actuator 10.

Having thus described the present embodiments in detail, it is to be appreciated and will be ap-parent to those skilled in the art that many physical changes, only a few of which are exemplified in the detailed description of the disclosure, could be made without altering the inventive concepts and principles embodied therein. It is also to be appreciated that numerous embodiments incorporating only part of the preferred embodiment are possible which do not alter, with respect to those parts, the inventive concepts and principles embodied therein.

The present embodiment and optional configurations are therefore to be considered in all respects as exemplary and/or illustrative and not restrictive, the scope of the disclosure being indicated by the appended claims rather than by the foregoing description, and all alternate embodiments and changes to this embodiment which come within the meaning and range of equivalency of said claims are therefore to be embraced therein.

### Log of Reference Numerals

10 solenoid actuator
12 coil
14 armature sleeve
16 longitudinally extending wall
18 end portion
20, 20′ armature
22, 22′ armature body
24, 24′ outer longitudinal surface
26, 26′ end surface
28 armature pin
30, 30′ oil reservoir space
32 wedge-shaped cross-section for 30
32′ rectilinear cross-section for 30′
40 housing
42 armature receiving space
44 coil receiving space
46 solenoid cover
48 actuator pin support
50 stop
52 opening
100 actuator assembly
102 support part
104 actuation part
C clearance
h1, h2 Height
r radius
X axis
Θ wedge angle

1. A solenoid actuator, the actuator comprising:
a coil at least partially surrounding an axis;
an armature sleeve extending at least partially through the coil, the armature sleeve including a longitudinally extending wall that extends generally parallel to the axis, and an end portion that extends inwardly at an end of the longitudinally extending wall;
an armature slidably supported in the armature sleeve for movement along the axis between at least first and second actuation positions, the armature having an armature body having an outer longitudinal surface facing the longitudinally extending wall and an end surface facing the end portion of the armature sleeve;
the longitudinally extending wall having a sliding fit with the outer longitudinal surface of the armature; and
an oil reservoir space formed on the armature in a region of an intersection between the outer longitudinal surface and the end surface of the armature.

2. The solenoid actuator of claim 1, further comprising a housing fixed to the coil and having an armature receiving space that receives at least a portion of the armature sleeve into which the armature is movable in at least one of the actuation positions and a coil receiving space in which the coil is located, and a solenoid cover located on an opposite side of the coil from the housing.

3. The solenoid actuator of claim 2, wherein an actuator pin extends from the armature and through the cover.

4. The solenoid actuator of claim 3, further comprising an actuator pin support connected to the cover, and a stop for the first actuation position of the armature formed on the actuator pin support, and the actuator pin extends through an opening in the actuator pin support.

5. The solenoid actuator of claim 1, wherein the oil reservoir space is annular.

6. The solenoid actuator of claim 5, wherein the annular space has a wedge-shaped cross-section.

7. The solenoid actuator of claim 6, wherein the annular space has a generally rectilinear cross-section.

8. The solenoid actuator of claim 6, wherein the annular space has a height of at least about 0.4 mm at the end surface of the armature.

9. The solenoid actuator of claim 1, wherein the longitudinally extending wall of the armature sleeve is generally cylindrical, and the outer longitudinal surface of the armature is generally cylindrical.

10. The solenoid actuator of claim 1, wherein the end portion of the armature sleeve forms a travel end stop for the second actuation position of the armature.

11. An actuator assembly, comprising:
a support part;
a solenoid actuator connected to the support part, the solenoid actuator having a coil at least partially surrounding an axis, an armature sleeve extending at least partially through the coil, the armature sleeve including a longitudinally extending wall that extends generally parallel to the axis, and an end portion that extends inwardly at an end of the longitudinally extending wall, and an armature slidably supported in the armature sleeve for movement along the axis between at least first and second actuation positions, the armature having an armature body having an outer longitudinal surface facing the longitudinally extending wall and an end surface facing the end portion of the armature sleeve, and an actuator pin extending from the armature; and
an actuation part that is acted upon by the actuator pin in at least one of the first or second actuation positions;
wherein the longitudinally extending wall has a sliding fit with the outer longitudinal surface of the armature, and an oil reservoir space is formed on the armature in a region of an intersection between the outer longitudinal surface and the end surface of the armature.

12. The actuator assembly of claim 11, wherein the support part is located in a wet area of a transmission.

13. The actuator assembly of claim 11, wherein the solenoid actuator further comprises a housing fixed to the coil and having an armature receiving space that receives at least a portion of the armature sleeve into which the armature is movable in at least one of the actuation positions and a coil receiving space in which the coil is located, and a solenoid cover located on an opposite side of the coil from the housing.

14. The actuator assembly of claim 13, wherein the solenoid actuator further comprises an actuator pin support connected to the cover, and a stop for the first actuation position of the armature formed on the actuator pin support, and the actuator pin extends through an opening in the actuator pin support.

15. The actuator assembly of claim 11, wherein the oil reservoir space is annular.

16. The actuator assembly of claim 15, wherein the annular space has a wedge-shaped cross-section.

17. The actuator assembly of claim 16, wherein the annular space has a generally rectilinear cross-section.

18. The actuator assembly of claim 16, wherein the annular space has a height of at least about 0.4 mm at the end surface of the armature.

19. The actuator assembly of claim 11, wherein the longitudinally extending wall of the armature sleeve is generally cylindrical, and the outer longitudinal surface of the armature is generally cylindrical.

20. The actuator assembly of claim 11, wherein the end portion of the armature sleeve forms a travel end stop for the second actuation position of the armature.
